(19) United States
(12) Patent Application Publication
(10) Pub. No.: US 2016/0085215 A1
(43) Pub. Date: Mar. 24, 2016

(54) TIMEPIECE HOLDER ASSEMBLY

(71) Applicant: Richard D Watler, JR., New Orleans, LA (US)

(72) Inventor: Richard D Watler, JR., New Orleans, LA (US)

(21) Appl. No.: 14/495,270

(22) Filed: Sep. 24, 2014

(51) Int. Cl. G04B 37/00

(52) U.S. Cl. CPC G04B 37/0008

(57) ABSTRACT

The invention relates to a timepiece holder for supporting a wrist watch in a freely suspended position on a user's garment, waist belt, etc. The holder has a disc-shaped body, on the front surface of which pin loops are secured. The pins loops receive lug pins of the watch and, projecting from the pin loops, the lug pins are engaged with the watch lugs when the watch lugs are aligned with the pin loops. A strap is detachably secured with the holder to allow suspension of the holder from the user's garment similar to a pocket watch.

### BACKGROUND OF THE INVENTION

This invention relates to an article holder and, more particularly to a device for holding a timepiece, such as a wrist watch in a manner similar to a pocket watch.

Wearable timepieces are generally divided into two groups: wrist watches and pocket watches. Pocket watches were fashionable and expensive original timepieces, which were worn by men and later by ladies as attractive jewelry items. When not worn a pocket watch could be positioned in a pocket watch holder that was designed for supporting the pocket watch on a table and allow the owner to view the watch face. Antique pocket watch holders can still be found in antique shops. Leather pocket watch pouches are also available. However, the pouches completely enclose the pocket watch making it impossible to tell time without taking the pocket watch out of the pouch.

With the arrival of a wrist watch, most pocket watches became obsolete, more a luxury item than a useful article. Conventional wrist watches are designed as a case secured to a flexible, sometimes stretchable, strap or bracelet. The strap is configured to be worn on the owner's wrist. The strap may be formed from fabric, plastic, stainless steel, precious metal, ribbon, etc. A conventional wrist watch case is provided with diametrically opposed pairs of spaced-apart lugs, between which bracelet-attaching pins are removably secured.

Wrist watches are universally worn by men, women and children. Traditionally, the watch face or dial is protected by a transparent glass plate, which can be damaged during work, sport activity or play. Many industrial facilities discourage the use of wristwatches in a workplace for safety reasons. It would be beneficial to provide a holder for supporting a wrist watch in a manner similar to a pocket watch, while allowing the user to easily view the dial without having to remove the watch from a pouch.

### SUMMARY OF THE INVENTION

It is, therefore, an object of the present invention to provide a timepiece holder than can support a wrist watch in a freely suspended state with the watch face exposed.

It is another object of the invention to provide a watch holder, which allows securing of a wrist watch using standard watch lugs and pins.

These and other objects of the invention are achieved through a provision of a watch holder assembly that allows converting a wrist watch to be supported in a manner similar to pocket watch. The wrist watch usually has a watch display, a pair of opposing lugs and a removable lug pin insertingly engageable with each of the lugs. The holder assembly comprises a disc-shaped holder body having a circumferential outer edge and a front surface, which supports the watch without covering the watch display with any flaps or covers. An attachment loop is secured to the circumferential edge at an upper portion of the holder body.

A first mounting loop is secured on the front surface a distance inwardly from the circumferential edge, and one of the lug pins is inserted therethrough when the watch upper watch lugs are aligned with the first mounting loop. A second mounting loop is secured on the front surface a distance inwardly from the circumferential edge in a location diametrically opposite the first mounting loop. The second mounting loop is configured to receive another lug pin therein when the lower lugs are aligned with the second mounting loop.

The assembly provides for the use of a strap means engageable with the attachment loop for suspending the holder body from a garment of the user and an attachment ring engaged with the attachment loop. The attachment ring forms an intermediate link between the strap means and the holder body.

### BRIEF DESCRIPTION OF THE DRAWINGS

Reference will now be made to the drawings, wherein like parts are designated by like numerals, and wherein

FIG. 1 is a front view of the timepiece holder member according to this invention.

FIG. 2 is a back view of the timepiece holder member according to this invention.

FIG. 3 illustrates a conventional wrist watch with the pins being removed from the lugs.

FIG. 4 is a front view of a wrist watch positioned in the holder member.

FIG. 5 is a front view of a self-closing clasp member of the holder assembly according to one embodiment of the present invention.

FIG. 6 is a belt engagement member of the holder assembly according to one embodiment of the present invention.

FIG. 7 illustrates a pair of shackle members of the holder assembly according to one embodiment of the present invention.

FIG. 8 is a plan view of an elongated noodle strap member of the holder assembly according to one embodiment of the present invention.

FIG. 9 is a loop strap member of the holder assembly according to a second embodiment of the present invention.

FIG. 10 is a perspective view of the timepiece holder assembly according to the first embodiment of the present invention.

FIG. 11 is a perspective view of the timepiece holder assembly according to the second embodiment of the present invention.

FIG. 12 illustrates the timepiece holder assembly as worn by a user when the elongated strap member and the loop strap members are connected to suspend the timepiece holder member.

### DETAIL DESCRIPTION OF THE INVENTION

Turning now to the drawings in more detail, numeral 10 designates the timepiece holder assembly according to the first embodiment of the present invention. The assembly 10 comprises a timepiece holder member 12, a lashing device, such as an elongated strap member 50 or 60, and a belt suspension member 16. The timepiece holder member 12 comprises a substantially circular disc-shaped holder body 20 having an outer circumferential edge 22. An attachment loop 24 is secured to the circumferential edge 22, and the portion of the holder body 20 where the attachment loop 24 is positioned is designated as an upper portion of the holder body 20.

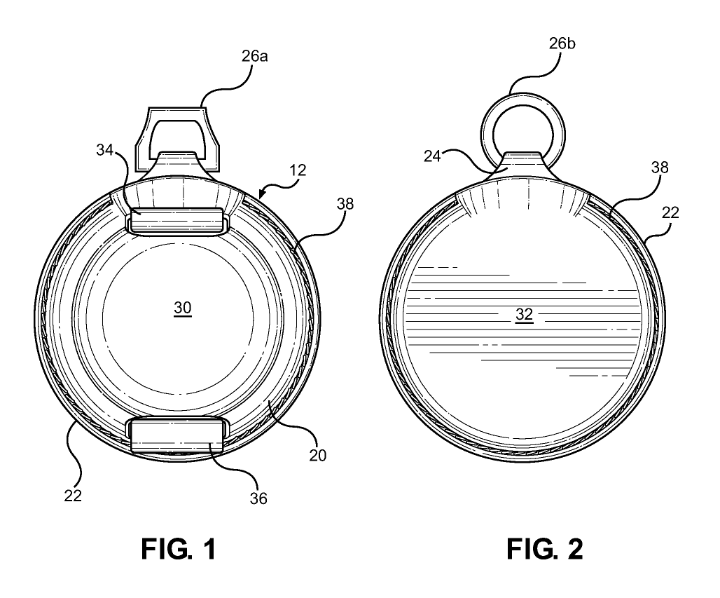

An attachment ring 26 is affixed to the attachment loop 24. The attachment ring 26 can be a D-shaped ring 26a, as shown in FIG. 1 or a circular ring 26b, as shown in FIG. 2. The attachment rings 26a and 26b can be continuous rings or split rings. The attachment rings extend outwardly from the circumferential edge 22 to a distance sufficient for engagement by a clamp or a shackle, as will be described in more detail hereinafter.

The holder body 20 has a front surface 30 and a back surface 32. A pair of mounting loops or pin loops 34 and 36 is secured in diametrically opposite locations to the front surface 30. The pin loops 34, 36 can be formed as elongated hollow cylinders, as folded pieces formed from flexible bendable material, or in any other desired manner. Each of the pin loops 34, 36 is configured for receiving a watch lug pin therethrough. The length of the mounting loops 34, 36 is at least slightly smaller than the length of the watch lug pin to allow the lug pins to project therefrom and be insertingly received in the watch lugs when the watch lugs are aligned with the mounting pins 34, 36.

If desired, an inner seam 38 can be formed in the holder body 20 a distance from the circumferential edge 22. The inner seam 36 can follow the circular configuration of the holder body 20 and be applied a distance inwardly from the outer circumferential edge 22. The pin loops 34, 36 can be stitched into the inner seam 36 at “12 o'clock” and “6 o'clock” location of the inner seam 38.

The back surface 32 of the holder body 20 is formed as a generally planar surface, with the inner seam 38 forming a raised edge. The inner seam 38 can also form a raised surface on the normally planar front surface 30. In one aspect of the invention, the holder body can be formed from two circular elements stitched together along the inner seam 38.

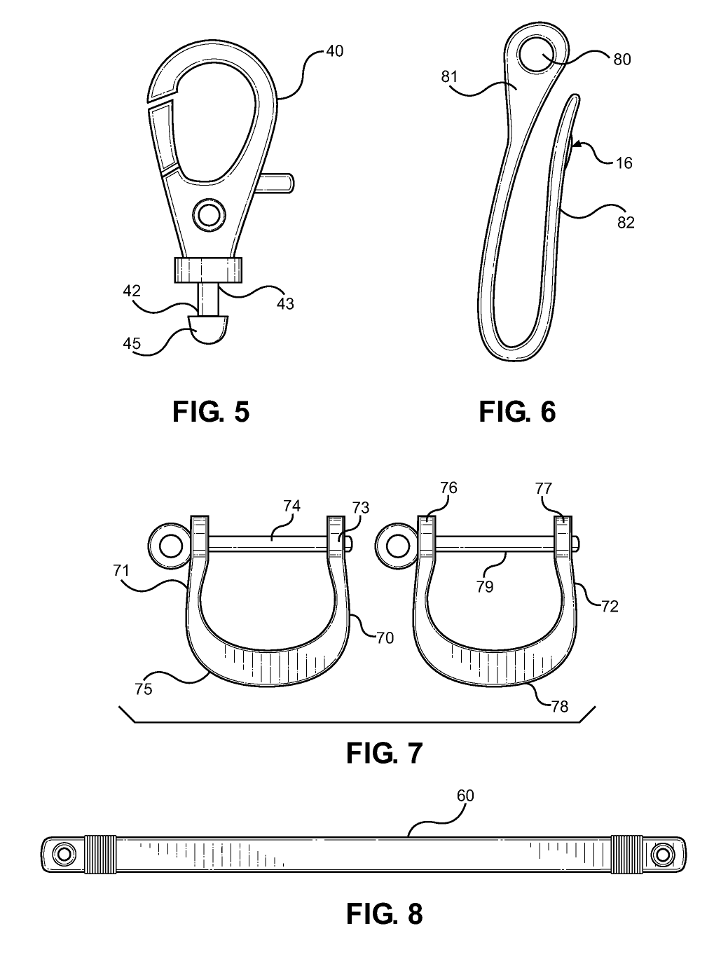

FIG. 5 illustrates a self-closing clasp member 40 used in one embodiment of the present invention. The clasp member 40 is configured as a lobster claw clasp, however, it is understood that the other clasps such as a spring ring clasp, a trigger or push lock clasp, a box clasp, a toggle clasp, a double-ended releasable clasp, etc. may be used in other alternative embodiments. The self-closing clasp member 40 has a ring in combination with a lobster claw shaped element which includes a hooking portion and a spring biased hook closing portion.

A securing leg 42 is affixed to the clasp member 40. The securing leg has a proximate elongated part 43 and an enlarged round distant part 45. The diameter of the distant part 45 is greater than the width of the proximate part 43. The securing leg 42 is configured for engaging the clasp member 40 with the attachment ring 26a or 26b while allowing free rotation of the clasp member in relation to the attachment ring and thus to the holder body 20. The proximate part 43 of the securing leg 42 passes through the body of the attachment ring 26; it has sufficient length to allow the distant part 45 to fit in the opening formed by the attachment ring 26, such that the enlarged distant part 45 contacts the underside of the attachment ring 26 and prevents disengagement of the clasp member 40 from the attachment ring 26.

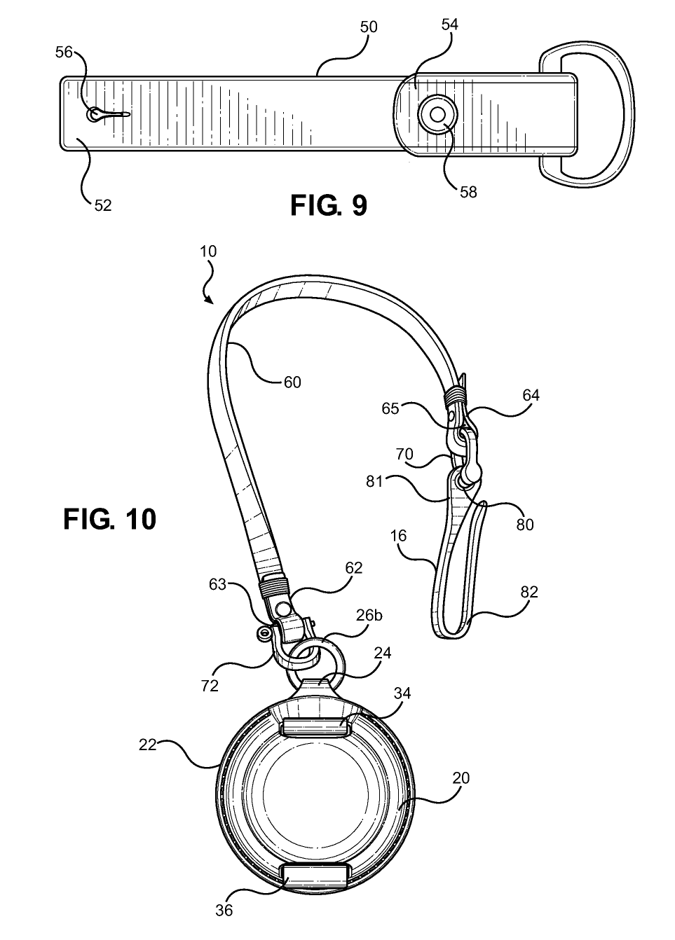

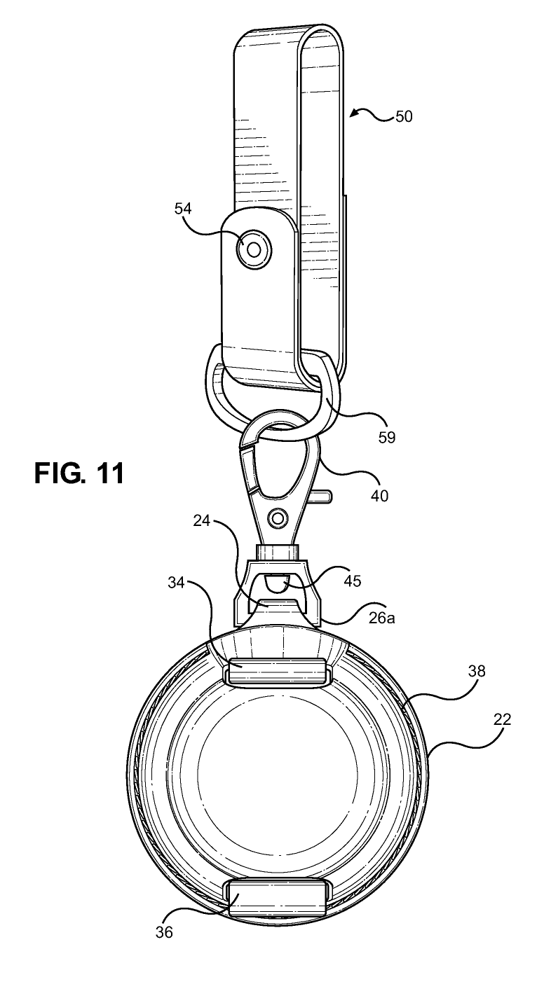

The loop strap member 50 illustrated in FIGS. 9 and 11 is configured for detachable engagement with the self-closing clasp member 40. The loop strap member 50 comprises a substantially planar length of flexible bendable material, such as leather, fabric, woven ribbon, and the like. The loop strap member 50 has a first end 52 and a second end 54. In one aspect of the invention, the loop strap member 50 has a rectangular cross section, although other shapes can certainly be used.

A button hole 56 is formed adjacent the first end 52 of the loop strap member 50. The second end 54 is folded on itself and is secured with a rivet 58. The head of the rivet 58 is configured for engaging with the button hole 56, as shown in FIG. 11, when the loop strap member 50 is folded as a loop.

A D-ring 59 is secured to the folded second end 54. The D-ring 59 has an opening large enough to allow the clasp member 40 to engage the D-ring when the loop strap member 50 is detachably engaged with the clasp member 40. Of course, the D-ring 59 is one of many alternative connecting members, and instead of D-rings, other shapes, configurations and/or forms of connectors can be used as would be apparent to those skilled in the art from this disclosure. When in use, the loop strap 50 is folded over a user's belt and then closed using the rivet 54, which engages with the buttonhole 56.

Turning now to the embodiment of FIGS. 6, 7, and 10, the noodle strap member 60 is seen comprising a length of flexible bendable natural or artificial narrow strip. The noodle strap member 60 has opposing ends 62, 64, each of which has an eye 63, 65, respectively. The eyes 63, 65 can be formed by folding the ends 62, 64 over and securing the ends by stitching, glue, ties, and the like.

The holder assembly according to this embodiment of the invention also comprises a pair of shackle members 70, 72 shown in detail in FIG. 7. The shackle member 70 has a pair of parallel legs 71, 73, which are unitary connected by an arcuate central part 75. The shackle member 72 also has a pair of parallel legs 76, 77 connected by a unitary central part 78. A removable shackle pin 74 engages free ends of the shackle legs 71, 73, and a similar removable shackle pin 79 engages free ends of the shackle legs 76. 77. If desired, the shackle pins 74 and 79 can be spring loaded.

The belt hook or the belt suspension member 16 is shown in detail in FIGS. 6 and 10. The belt suspension member 16 is formed as a hook-shaped body having a hook eye 80 formed on a first end 81 thereof and a U-shaped bent shank 82 unitary continuously formed with the first end 81. As can be seen in FIG. 10, the holder body 20 is suspended from the belt suspension member 16 using a shackle 70 detachably engaged between the hook eye 80 and the end 64 of the noodle strap member 60. The end 62 of the noodle strap member 60 is detachably engaged to the shackle 72 and the attachment ring 26b of the timepiece holder member 12. In use, the wearer hooks the belt suspension member 16 over a waist belt 84 (FIG. 8) using the bent shank 82.

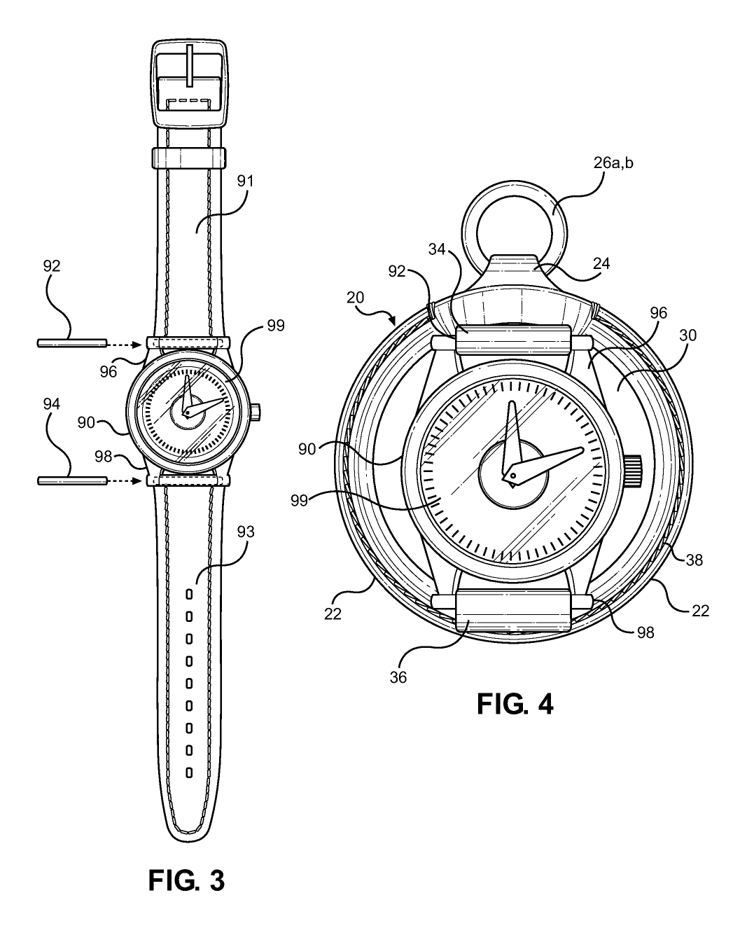

A conventional wrist watch 90 illustrated in FIG. 3 has a watch casing with the watch display 99, associated timekeeping mechanism and a pair of opposing lugs 96, 98. Lug pins 92, 94 insertingly engage the lugs 96, 98 respectively to secure the wrist band portions 91, 93 to the watch 90. To position the wrist watch 90 on the timepiece holder body 20, the user removes the lug pins 92, 94 from their engagement with the watch lugs 96, 98 thereby releasing the wrist band portions 91 and 93. The user then aligns the watch lugs 96, 98 with the pin loops 34, 36 and inserts the lug pins 92, 94 into the pin loops 34, 36 of the holder body 20. The 12 o′clock position of the watch display 99 is oriented toward the attachment loop 24 of the holder body 20. The watch 90 is thus removably secured on the front of the holder body 20, with the watch display 99 not obscured by a flap, fold, and the like.

The user then secures one of the lashing devices to the attachment ring 26 using either the loop strap 50 or the noodle strap 60. The intermediate connectors, such as the D-ring and shackles 70, 72 are used to freely suspend the holder body 20 from the straps. The user then suspends the timepiece holder assembly 10 from the belt using either the loop strap 50 or the belt hook 16.

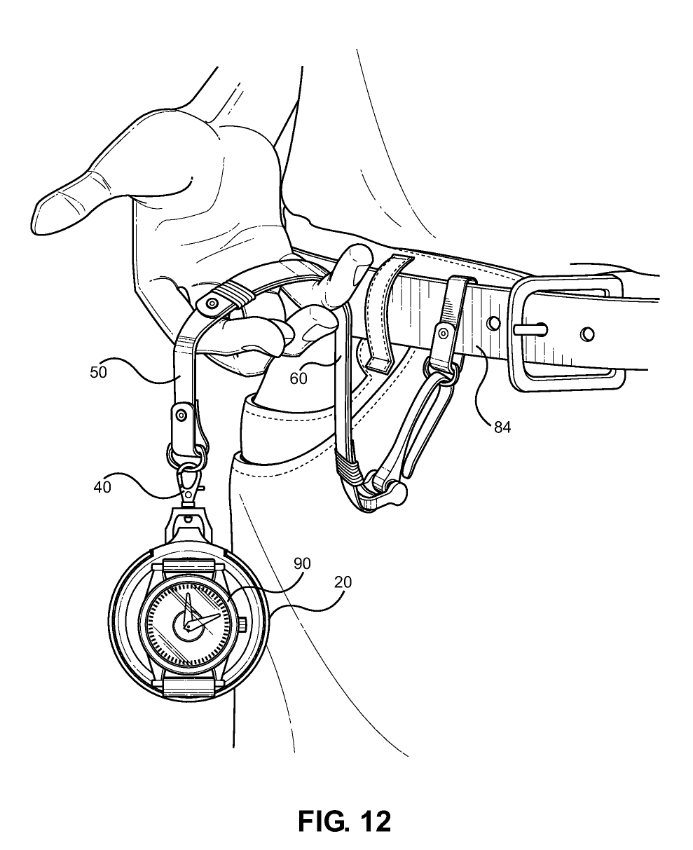

FIG. 12 illustrates an alternative of the strap suspension means where the loop strap 50 is used in combination with the noodle strap. It is envisioned that such alternative will be particularly useful when a longer lashing device is desired. The watch can be either freely suspended from the user's waist belt, a pocket or another convenient location on the user's garment. The watch engaged with the holder body 20 can be placed in a user's pocket or remain freely suspended with its face exposed. The watch 90 remains stationary on the holder body 20 allowing the user to use his arms without the fear of the watch glass being damaged during work or exercise.

As further alternatives, the straps 50 and 60 can be substituted by a chain or another decorative device. If the watch is small the lugs 96, 98 may not be properly aligned with the pin loops 34, 36. In such case, it is possible to use a small piece of elastic tape to “stretch” position of the watch pins and align them with the pin loops 34, 36.

The timepiece holder body 20, as well as straps 50 and 60 can be formed from leather, natural or artificial, strong fabric, woven fabric or a variety of other suitable materials. The hardware, that is the rings, clasps and shackles can be made of metal, metal alloys, plastic, etc. The back surface of the holder body 20 can be decorated with a company logo, sports team logo, fanciful design, etc. The front surface of the holder body similarly can decorated using crystals, stones, decorative indicia and the like.

Many other changes and modifications can be made in the design of the present invention without departing from the spirit thereof. I, therefore, pray that my rights to the present invention be limited only by the scope of the appended claims.

I claim:

1. A holder assembly for a wrist watch having a watch display, a pair of opposing lugs and a removable lug pin insertingly engageable with each of the lugs, the holder assembly comprising:
a holder body having a circumferential outer edge and a front surface, the holder body being configured for supporting the wrist watch without covering the watch display;
an attachment loop secured to the circumferential edge;
a first pin loop secured on the front surface a distance inwardly from the circumferential edge, said first pin loop being configured to receive a lug pin therein;
a second pin loop secured on the front surface a distance inwardly from the circumferential edge in a location diametrically opposite the first pin loop, said second pin loop being configured to receive another lug pin therein; and
a strap means engageable with the attachment loop for suspending the holder body from a garment of the user.

2. The assembly of claim 1, comprising an attachment ring engaged with the attachment loop and configured for engagement between the strap means and the attachment loop.

3. The assembly of claim 1, the strap means comprising an elongated loop strap having a D-ring secured to one end, a rivet secured to the loop strap a distance from the D-ring, and a buttonhole formed adjacent an opposite end of the loop strap.

4. The assembly of claim 3, wherein the loop strap is configured to form a loop for suspending the holder body from the user's garment when the rivet is insertingly positioned in the buttonhole.

5. The assembly of claim 2, comprising a clasp member detachably engageable between the strap means and the attachment ring.

6. The assembly of claim 5, wherein the clasp member is a self-closing clasp.

7. The assembly of claim 6, wherein the self-closing clasp is a lobster-claw clasp having a securing leg attached thereto, the securing leg being configured for attachment to the attachment ring.

8. The assembly of claim 7, the securing leg comprising a proximate elongated part and an enlarged round distant part, and wherein the diameter of the distant part is greater than the width of the proximate part.

9. The assembly of claim 7, wherein the securing leg is configured for engaging the clasp member with the attachment ring while allowing free rotation of the clasp member in relation to the attachment ring and the holder body.

10. The assembly of claim 2, the strap means comprising an elongated noodle strap having a pair of strap ends and a shackle member detachably engageable with each of the strap ends.

11. The assembly of claim 10, wherein one of the shackle members is configured for detachable engagement with the attachment ring of the holder body.

12. The assembly of claim 11, comprising a belt suspension member configured for detachable engagement with the second of the shackle members.

13. The assembly of claim 12, wherein the belt suspension member comprises a hook-shaped member.

14. The assembly of claim 1, wherein the pin loops have a predetermined length, which is at least slightly smaller than a length of the lug pins so that the lug pins can project from the pin loops and engage the lugs when the lugs are aligned with the pin loops.

15. A holder assembly for a wrist watch having a watch display, a pair of opposing lugs and a removable lug pin insertingly engageable with each of the lugs, the holder assembly comprising:
a holder body having a circumferential outer edge and a front surface, the holder body being configured for supporting the wrist watch on the front surface without covering the watch display;
an attachment loop secured to the circumferential edge;
a first mounting loop secured on the front surface a distance inwardly from the circumferential edge, said first mounting loop being configured to receive a lug pin therein;
a second mounting loop secured on the front surface a distance inwardly from the circumferential edge in a location diametrically opposite the first mounting loop, said second mounting loop being configured to receive another lug pin therein;
an attachment ring engaged with the attachment loop; and
a strap means engageable with the attachment loop for suspending the holder body from a garment of the user.

16. The assembly of claim 15, the strap means comprising an elongated loop strap having a D-ring secured to one end, a rivet secured to the loop strap a distance from the D-ring, and a buttonhole formed adjacent an opposite end of the loop strap, the loop strap being configured to form a loop for suspending the holder body from the user's garment when the rivet is insertingly positioned in the buttonhole.

17. The assembly of claim 15, comprising a self-closing clasp member detachably engageable between the strap means and the attachment ring.

18. The assembly of claim 17, wherein the self-closing clasp is a lobster-claw clasp having a securing leg attached thereto, the securing leg being configured for attachment to the attachment ring.

19. The assembly of claim 18, the securing leg comprising a proximate elongated part and an enlarged round distant part, and wherein the diameter of the distant part is greater than the width of the proximate part, wherein the securing leg is configured for engaging the clasp member with the attachment ring while allowing free rotation of the clasp member in relation to the attachment ring and the holder body.

20. The assembly of claim 15, the strap means comprising an elongated noodle strap having a pair of strap ends and a shackle member detachably engageable with each of the strap ends.

21. The assembly of claim 20, wherein one of the shackle members is configured for detachable engagement with the attachment ring of the holder body.

22. The assembly of claim 21, comprising a hook-shaped belt suspension member configured for detachable engagement with the second of the shackle members.

23. The assembly of claim 15, wherein the mounting loops have a predetermined length, which is at least slightly smaller than a length of the lug pins so that the lug pins can project from the mounting loops and engage the lugs when the lugs are aligned with the mounting loops.
